(19) United States
(12) Patent Application Publication
(10) Pub. No.: US 2003/0221884 A1
(43) Pub. Date: Dec. 4, 2003

(54) Hybrid power driving apparatus and its controlling method

(75) Inventors: Ping-Huei Shu, ChiungLin Hsiang (TW); Chien-Tsung Wu, Hsinchu (TW); Chi-Tang Hsu, Hsinchu (TW); Chun-Hsien Lu, Hsinchu (TW); Kai-Ching Hsieh, Taipei (TW); Chih-Chung Lo, PingTung (TW); Tzeng-Te Wei, Hsinchu (TW); Huan-Lung Gu, HuaLien (TW)

Correspondence Address: BRUCE H. TROXELL, 5205 LEESBURG PIKE, SUITE 1404, FALLS CHURCH, VA, 22041, US

(73) Assignee: Industrial Technology Research Institute

(21) Appl. No.: 10/216,743

(22) Filed: Aug. 13, 2002

(30) Foreign Application Priority Data
May 31, 2002 (TW) 91111620

(51) Int. Cl. B60K 6/02

(52) U.S. Cl. 180/65.4

(57) ABSTRACT

The invention relates to a hybrid power driving apparatus and its controlling method, especially using different types of power sources to cooperate them in parallel with each other. Due to a way of combining power sources in parallel, a single power source is able to be operated independently for not wasting energy under a condition of not combining power sources. The hybrid power diving apparatus comprise at least one controlling system apparatus, one electric driving apparatus, one fuel driving apparatus, one auto-control clutch apparatus and one integrated power assistant apparatus.

### BACKGROUND OF THE INVENTION

1. Field of the Invention

The invention is a hybrid power driving apparatus and its controlling method. More specifically, the invention involves different types of power sources working in conjunction to power a motor vehicle; but in situation when plural power sources is not necessary, the invention can still power the vehicle with just one of its sources, saving energy.

2. Background of the Invention

In recent years, as rapid development of the human race is entering a stage of convenient, civilized lifestyle, the price we pay is far greater than what we could have imagined. Not only are we endangering the lives of everyone on this planet, but also the planet itself and all other life forms living on it. As a more recent example, the hole in the ozonosphere, caused by none else but humanity, is causing some serious problems worldwide, such as global warming and the various forms of pollution. The phenomenal increase of temperatures and strange occurrences, like snow falling in June, all result from our own selfish wants. In conclusion, if we do not address these problems soon, the future of the human race lies on the path to destruction.

According to current studies, the main source of pollution is mostly from automobiles and other transportation vehicles. Through the mobility of transportation vehicles, pollution inherits its mobility and is able to contaminate every corner of our planet. On land, cars, motorcycles, and other land transportation vehicles emit harmful gases in every city. In the air, airplanes spread their pollutants through the air, onto land, and into the sea. By sea, vessels empty their waste products directly into the ocean, contaminating the aquatic environment. This kind of “3-dimensional” pollution intensifies the contamination already present from stationary units. Therefore, if there is a much more environment-friendly energy solution or a way to minimize fuel consumption without sacrificing efficiency, then we should most certainly consider it. In the last 20 years, an environmental awareness gradually took shape; scientists and biologists alike strive on a path to advance development without doing further damage to our environment. With the invention of the electric vehicle, the use of solar power, and the development of anthracite technology, we are well on our way towards a greener future.

Looking back at prior arts, we only have a single source of power, which is evident in all of the following: diesel engines, gasoline engines, solar-powered systems, electric-powered systems, etc. Some of these systems are very efficient and durable, but lack an environmental concept; some are very clean, but inefficient. For example, electric automobiles and solar-powered automobiles both have very low emissions, but their energy potentials and efficiencies have technical limitations. As implied above, using only one form of power source will not work; therefore, the new technology and design of combining two different types of power sources is developed after thorough research. With this design, not only can the vehicle reach its required efficiency and durability, but it also possesses an environmental standpoint. This new idea and design is the core feature of this invention.

### SUMMARY OF THE INVENTION

The main objective of this invention is to save energy by using the traditional internal combustion engine and the electric motor together or alone under different circumstances. With the advantage of having two power sources, it can use its two power sources together, just the electric motor, or just the internal combustion engine to achieve the greatest efficiency and to save the most energy.

The secondary objective is to reduce emissions of the propulsion system in order to protect the environment. When only the electric motor is used or only the internal combustion engine is running at high efficiency, there will be less pollution released by the vehicle. In fact, if the majority of automobiles switch to a hybrid power source system, the amount of pollution emitted per year will decrease drastically and the preservation of the environment will become easier.

This energy-saving, low-emission hybrid propulsion system that uses both electric motor and combustion engine has the following features: the engine does not necessarily need to be in idle running when the vehicle is temporarily stopped, energy may be retrieved when applying the brakes, reduces the amount of time the engine is running at low speed and/or low loading conditions, the electric motor assists the propulsion system to achieve the maximum acceleration. These features effectively save the motor vehicle's energy and greatly reduce pollution to protect our environment.

To approach aforesaid objectives, please refer to following figures for more detail.

### BRIEF DESCRIPTION OF THE DRAWINGS

FIG. 1 is a scheme of a system structure of the present invention.

FIG. 2 is a flow chart of a method of the present invention.

FIG. 3 is a scheme of a related hardware structure of the method for the present invention.

FIG. 4 is a scheme of internal controlling functions of a system controlling apparatus for the present invention.

FIG. 5 to FIG. 19 are preferred embodiments of the present invention.

### DETAILED DESCRIPTION OF THE PREFERRED EMBODIMENTS

The present invention is a hybrid power driving apparatus and its controlling method, and it is to cooperate a traditional fuel device and system with an electric power system becoming a hybrid power structure with multi-function, high efficiency and high performance.

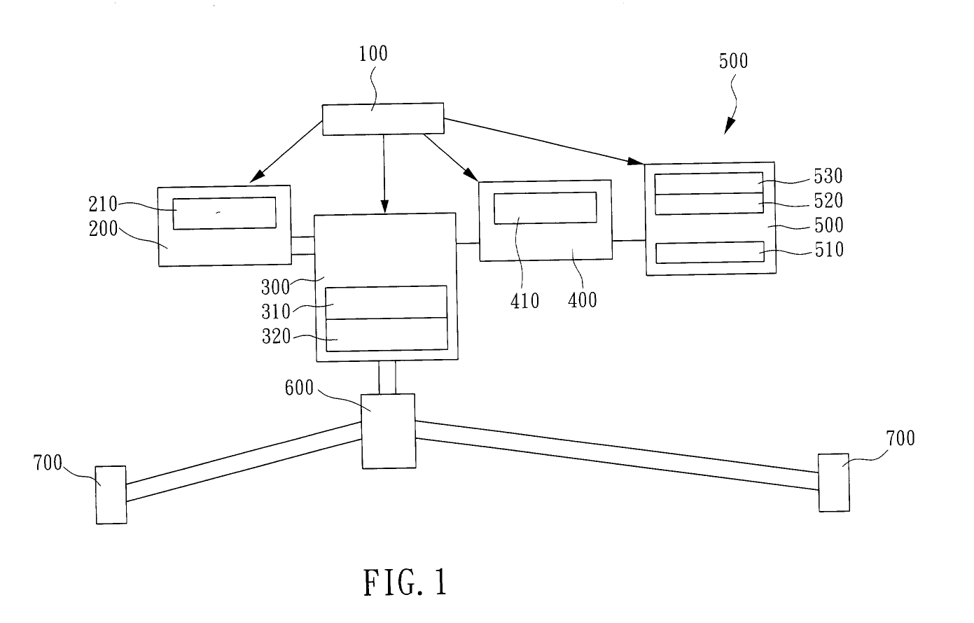

Referring to FIG. 1, which is a scheme of a system structure of the present invention; a plurality of wheels 700 and a differential mechanism 600 show positions relative to a layout in a vehicle, and the wheels can be a pair of front wheels or rear wheels, because the present invention suits both situations of front wheel driving and rear wheel driving, the present invention adopts a way of combining a plurality of power sources to drive a vehicle, the power sources are as following: electric power, fuel, solar energy, etc., the present invention is to join electric power and fuel together to form a type of hybrid power; hence a single power source can also be applied when not using both power sources, the present invention comprises: at least one controlling system apparatus 100, which controls coordinating actions among components of the present invention; at least one electric driving apparatus 200, which is a first driving source of the present invention and driven by electric power, generally the electric driving apparatus 200 is a motor, and further including a controlling motor unit 210 for being as a middle role to let the controlling system apparatus 100 handling electric driving apparatus 200; at least one fuel driving apparatus 400, which is a second driving source of the present invention and driven by fuel, the fuel can be one of following: gasoline, diesel oil, etc., the fuel driving apparatus 400 is normally an engine, further including a controlling engine unit 410 for controlling system apparatus 100 handling fuel driving apparatus 400; at least one auto-control clutch apparatus 300, which handles clutching actions between fuel driving apparatus 400 and electric driving apparatus 200, namely the auto-control clutch apparatus 300 is in between fuel driving apparatus 400 and electric driving apparatus 200 to separate and combine both of them, auto-control clutch apparatus 300 further includes an auto-control clutch 310 and a continuous variable transmission 320, the auto-control clutch 310 departs and combines fuel driving apparatus 400 and electric driving apparatus 200 for parallel connection driving, the continuous variable transmission 320 and electric driving apparatus 200 are always combined together of a mechanism, fuel driving apparatus 400 and auto-control clutch 310 of auto-control clutch apparatus 300 are always departed of a mechanism, which is driven by auto-control clutch apparatus 300 for combining, that is when vehicle needs more power, auto-control clutch apparatus 300 is able to connect with fuel driving apparatus 400 in parallel connection immediately for adding more power, and vise versa, furthermore fuel driving apparatus 400 is with a feature of fast starting as well; at least one integrated power assistant apparatus 500, which connects to fuel driving apparatus 400, and thus the integrated power assistant apparatus 500, fuel driving apparatus 400 and auto-control clutch apparatus 300 are connected in series, integrated power assistant apparatus 500 further includes a starting generator 510, a multi-stage power switch unit 520 and a controlling battery unit 530, a condition of not having enough power and fuel driving apparatus 400 is added to supply more power, fuel driving apparatus 400 is fast started by the starting generator 510, after fuel driving apparatus 400 being started, integrated power assistant apparatus 500 is then changed its role as a generator by multi-stage power switch unit 520 for sharing running loading of fuel driving apparatus 400, on the other hand, if further power is still needed, integrated power assistant apparatus 500 immediately switches to a role of auxiliary power via multi-stage power switch unit 520, besides, integrated power assistant apparatus 500 starts fuel driving apparatus 400 by means of the controlling battery unit 530 for offering electric power and cooperates with multi-stage power switch unit 520 to reclaim spare electric power from fuel driving apparatus 400 when fuel driving apparatus 400 is in normal operation.

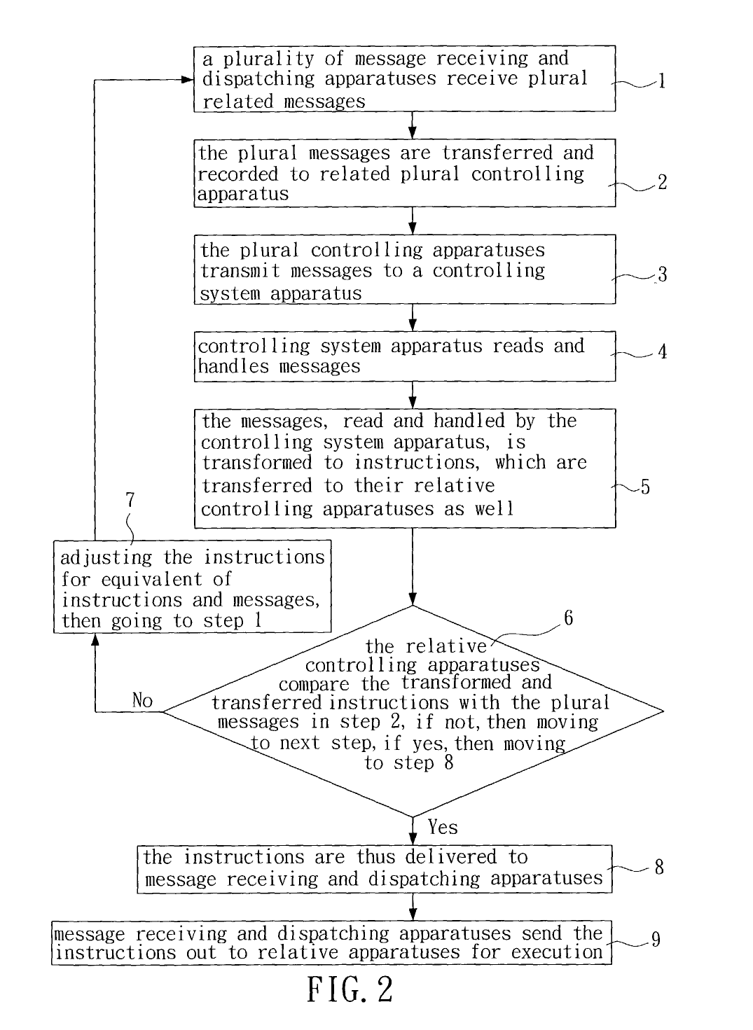

Referring to FIG. 2, which is a flow chart of a method of the present invention; the present invention adopts the way of combining a plurality of power sources to drive a vehicle, the power sources are as following: electric power, fuel, solar energy, etc., and its method comprises following steps:

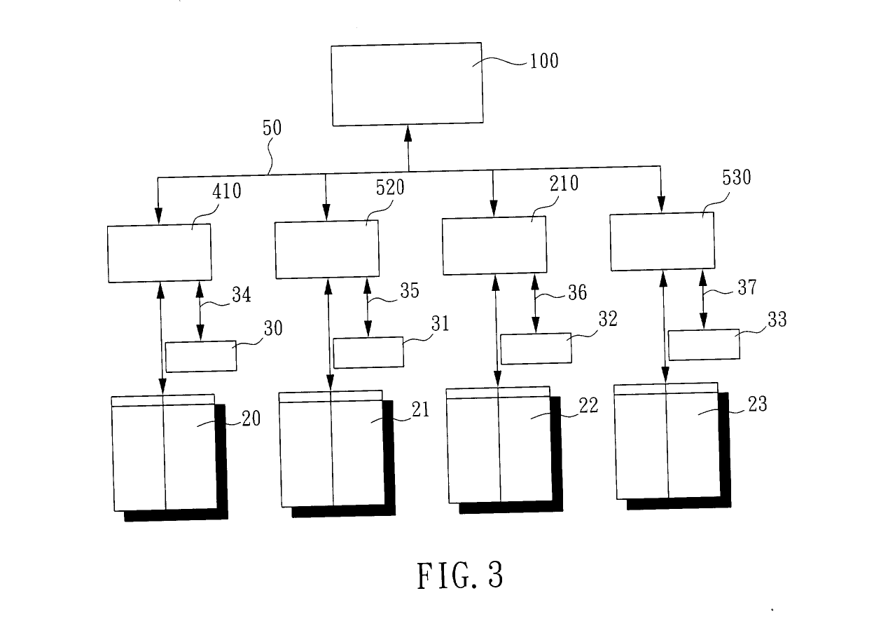

step 1: a plurality of message receiving and dispatching apparatuses 20, 21, 22 and 23 (refer to FIG. 3) receive plural related messages, which including conditions of neat status, gradient status, loading, etc. of road;

step 2: the plural messages are transferred and recorded to related plural controlling apparatus, and the plural controlling apparatus record some other messages relative to the plural messages, wherein, the plural controlling apparatuses include the controlling engine unit 410, handling fuel driving apparatus 400, multi-stage power switch unit 520, handling integrated power assistant apparatus 500, controlling motor unit 210, handling electric driving apparatus 200, and controlling battery unit 530, handling integrated power assistant apparatus 500;

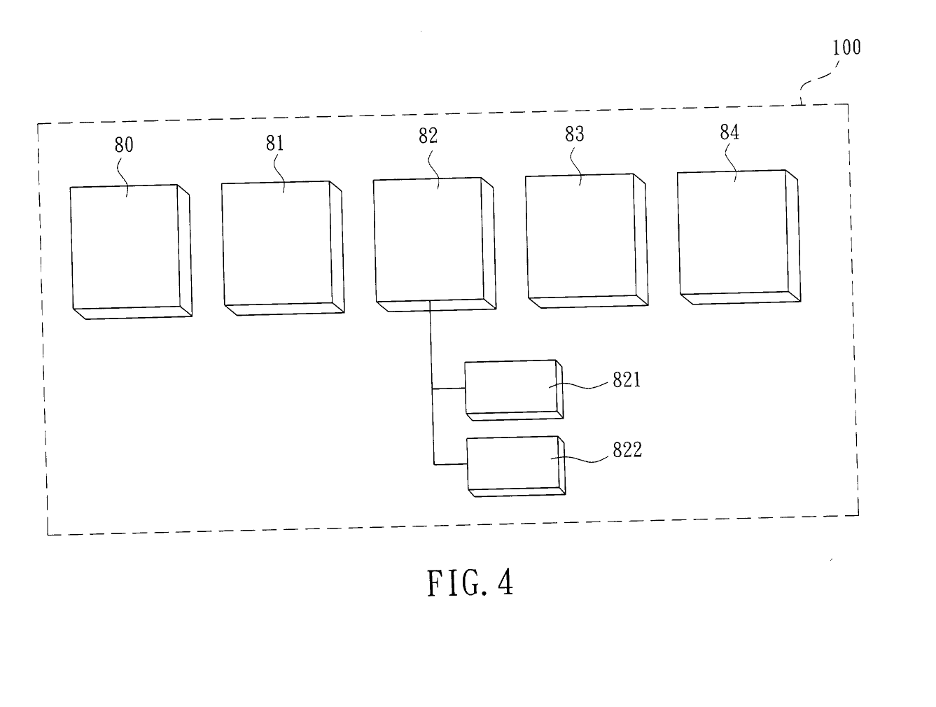

step 3: the plural controlling apparatus transmit messages to controlling system apparatus 100, which internal software executes following functions (refer to FIG. 4): message acquirement 80, message communication 81, controlling system derivation 82, plural instruments' messages recording 83 and messages judgments 84, wherein, the controlling system derivation 82 is capable to execute plural power sources combining modes selections 821 and plural power sources operation conditions judgments 822 depending on external conditions of vehicles;

step 4: controlling system apparatus 100 reads and handles messages;

step 5: the messages, read and handled by controlling system apparatus 100, is transformed to instructions, which are transferred to their relative controlling apparatuses as well;

step 6: the relative controlling apparatuses compare the transformed and transferred instructions with the plural messages in step 2, if not, then moving to next step, if yes, then moving to step 8;

step 7: adjusting the instructions for equivalent of instructions and messages, then going to step 1;

step 8: the instructions are thus delivered to message receiving and dispatching apparatuses 20, 21, 22 and 23;

step 9: message receiving and dispatching apparatuses 20, 21, 22 and 23 send the instructions out to relative apparatuses for execution, the relative apparatuses include electric driving apparatus 200, fuel driving apparatus 400 and integrated power assistant apparatus 500, wherein, electric driving apparatus 200 can be a motor, fuel driving apparatus 400 can be an engine, integrated power assistant apparatus 500 further includes starting generator 510, multi-stage power switch unit 520 and controlling battery unit 530, auto-control clutch 310 separates and combines electric driving apparatus 200 and fuel driving apparatus 400 for driving in parallel connection, hence the hybrid driving method of the present invention is achieved via motions of the apparatuses.

Please refer to FIG. 3, which is a scheme of a related hardware structure of the method for the present invention; from bottom of the FIG. 3, each message is acquired by related message receiving and dispatching apparatuses, such as message receiving and dispatching apparatuses 20 to 23, received messages are sent to related controlling apparatuses by means of a controlling CAN bus 50, for instance, the related controlling apparatuses are as controlling engine unit 410, multi-stage power switch unit 520, controlling motor unit 210 and controlling battery unit 530, and aforesaid apparatuses record the received messages simultaneously, continuously, messages are conveyed to controlling system apparatus 100 via controlling CAN bus 50, and controlling system apparatus 100 can read and control those messages for transforming to instructions, again the instructions, transformed messages, are relocated to controlling engine unit 410, multi-stage power switch unit 520, controlling motor unit 210 and controlling battery unit 530, the controlling units compare the previously recording messages with the instructions transferred from serial communication interfaces 34, 35, 36 and 37 to a collating tool 30, plural diagnosis tools 31, 32 and 33, if so, instructions are brought to message receiving and dispatching apparatus 20, 21, 22 and 23, finally instructions are collected and consulted by controlling system apparatus 100 for coordinating complicate motions, if not, then instructions must be adjusted for equivalent of instructions and messages and go back to their related message receiving and dispatching apparatuses for resending new instructions.

Please refer to FIG. 4, which is a scheme of internal controlling functions of a system controlling apparatus for the present invention; and there are a plurality of function block diagrams 80, 81, 82, 83 and 84 showing different functions, function block diagram 80 in controlling system apparatus 100 is to acquire messages from controlling CAN bus 50, function block diagram 81 in controlling system apparatus 100 is to communicate delivered messages, function block diagram 82 in controlling system apparatus 100 is to derive system control, and motions of derivation include function block diagram 821 of plural power sources combining modes selections and function block diagram 822 of plural power sources operation conditions judgments, function block diagram 83 in controlling system apparatus 100 is to record plural instruments' messages, thus after integrating aforesaid functions, cooperation of software and hardware is then completed.

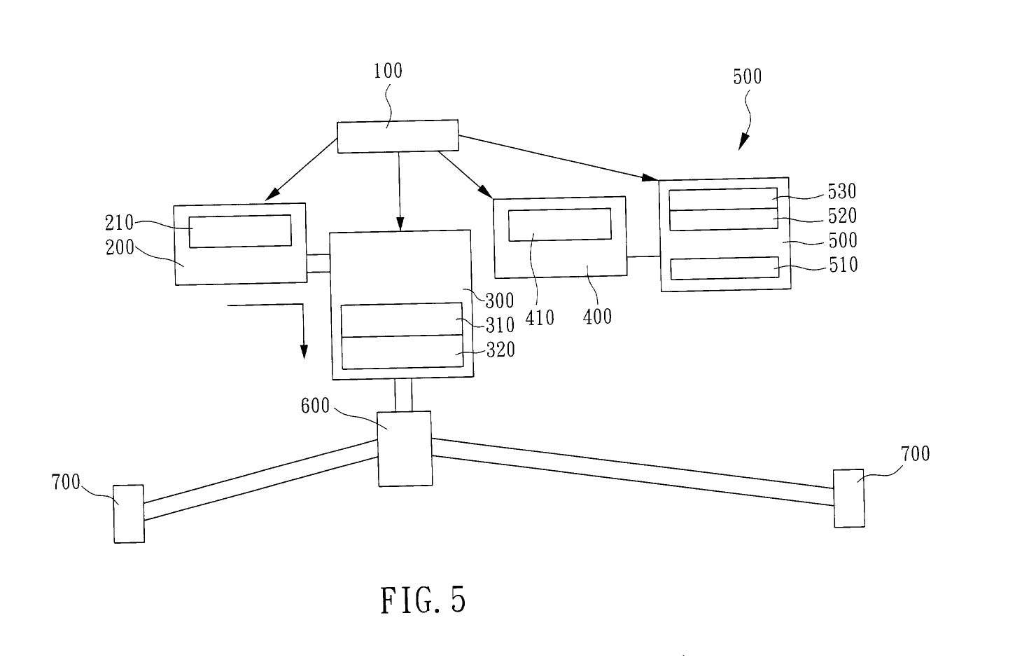

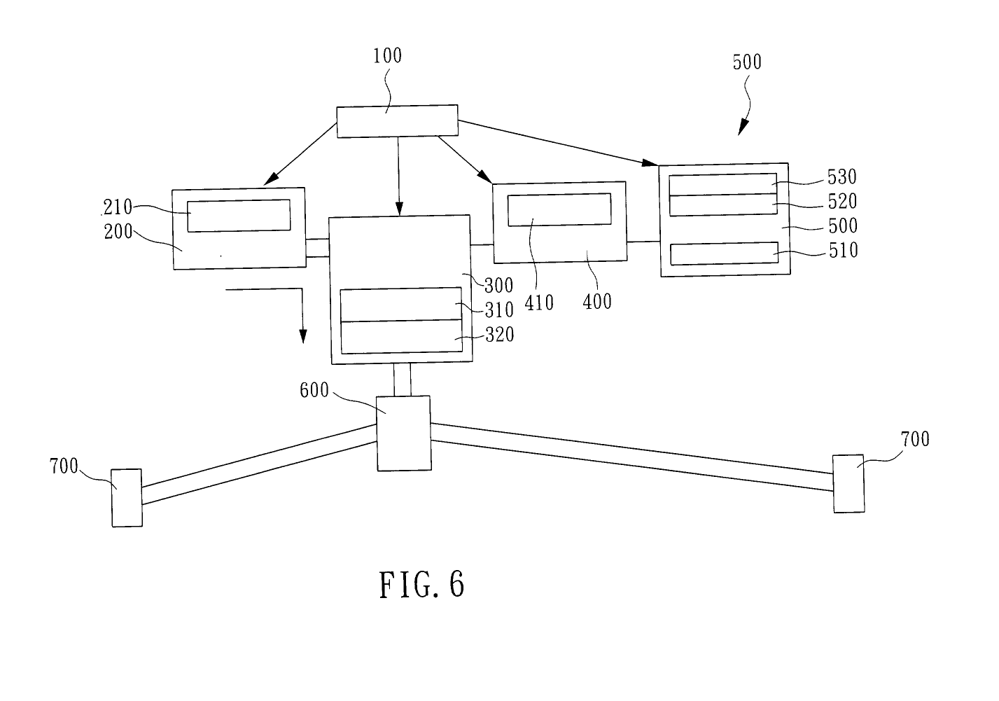

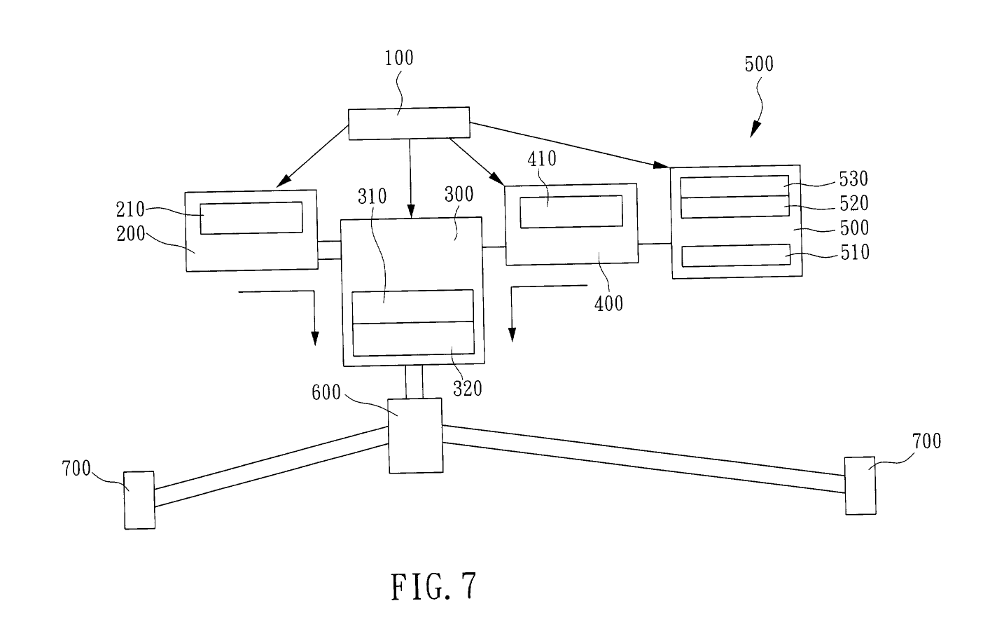

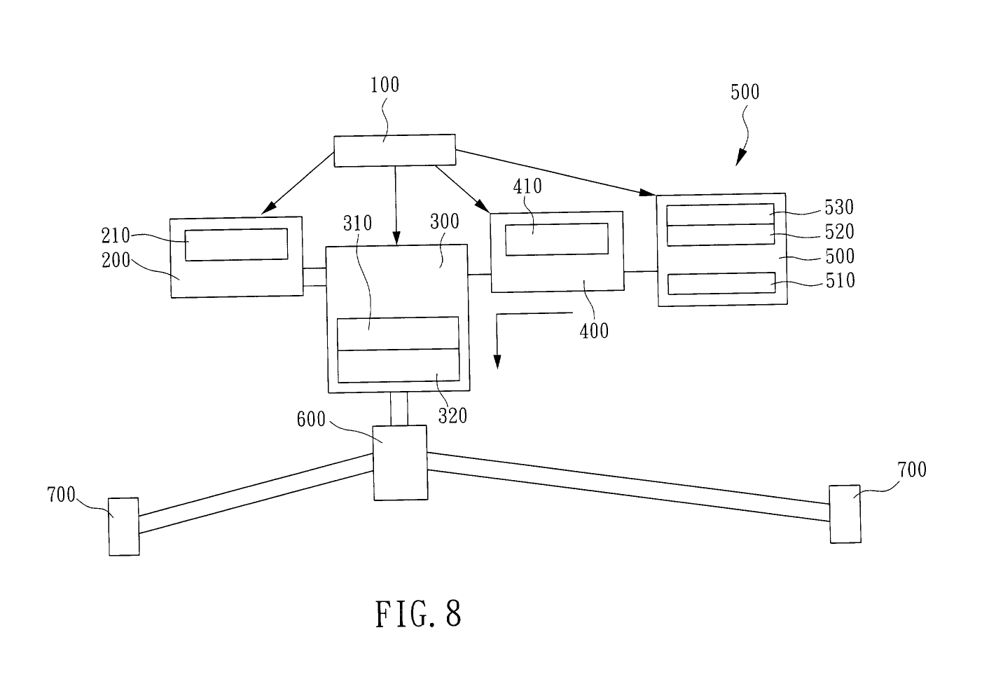

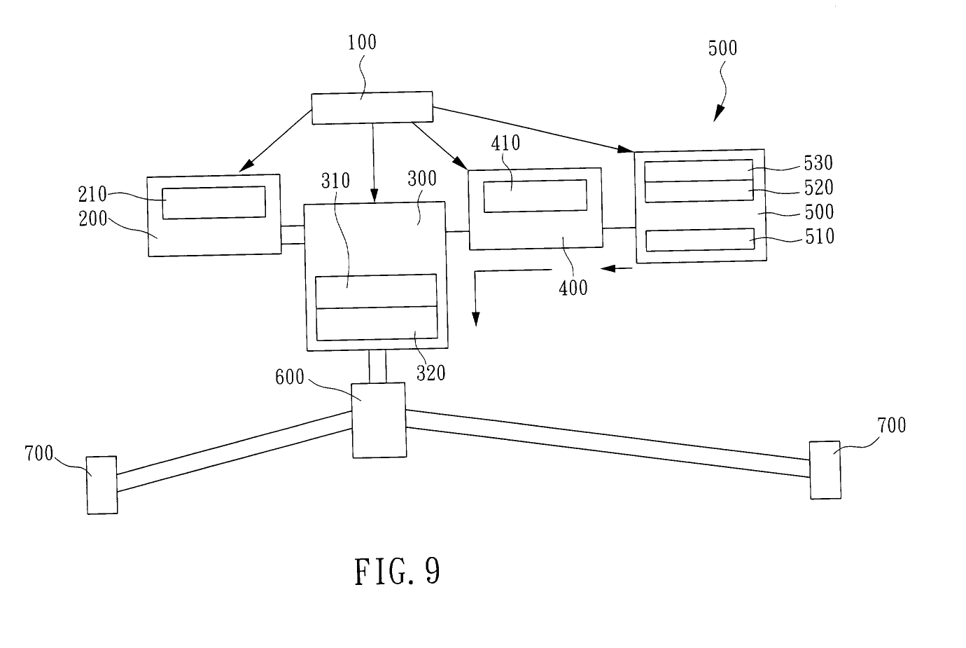

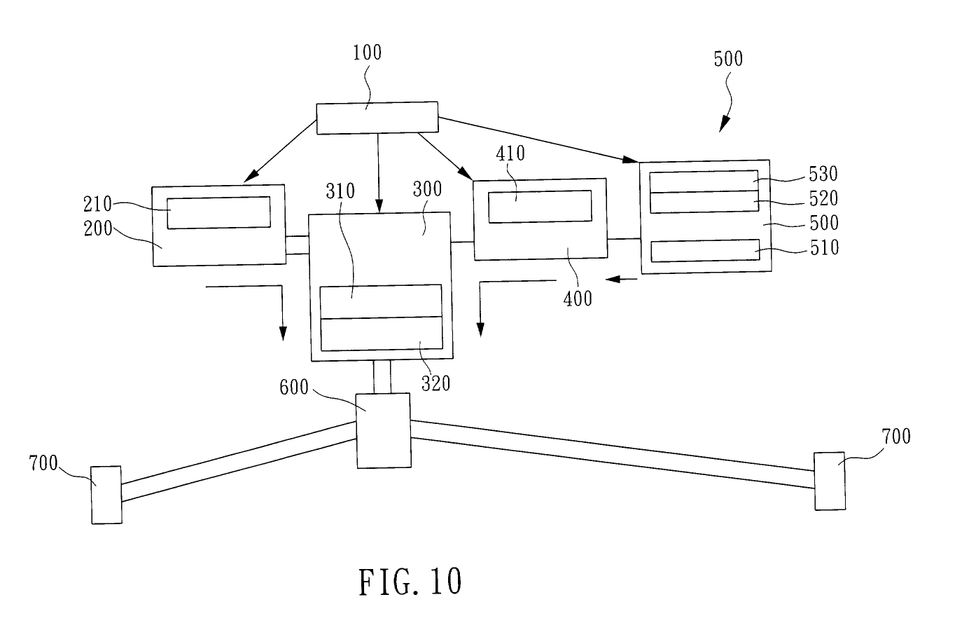

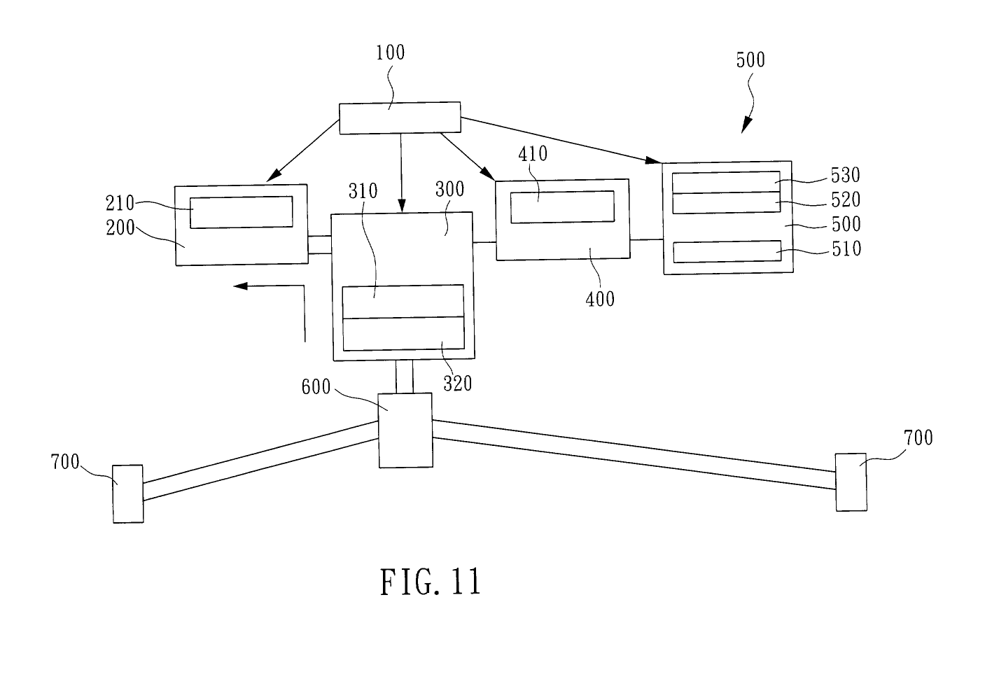

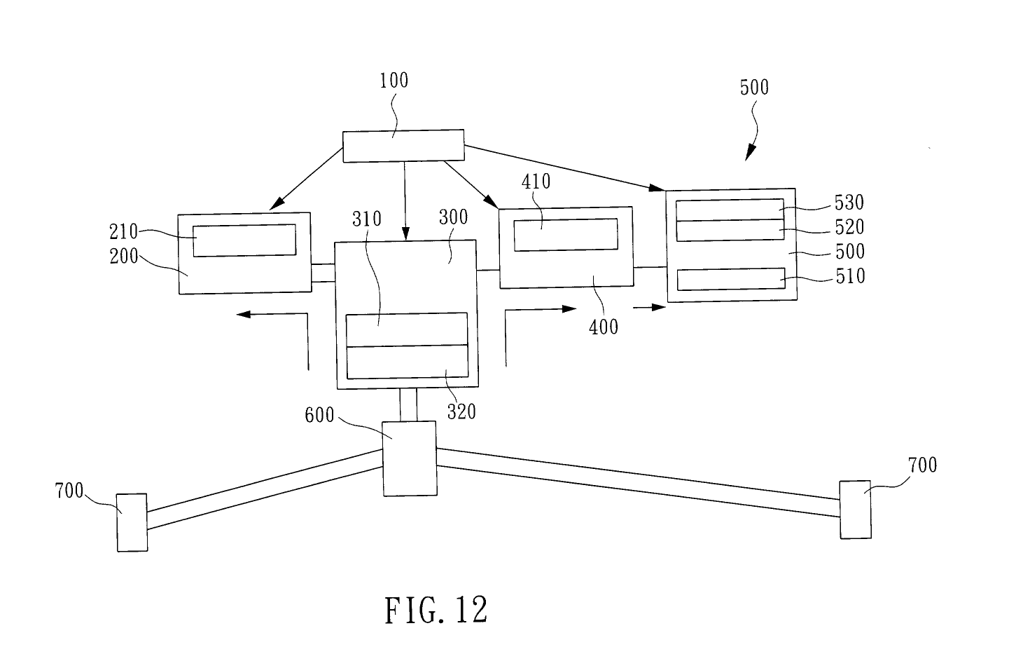

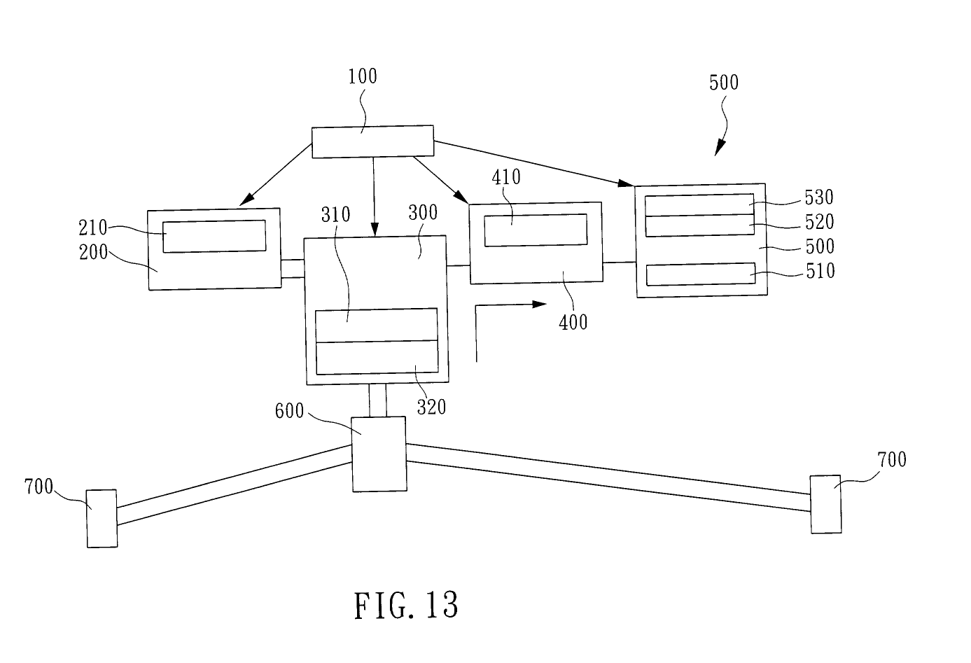

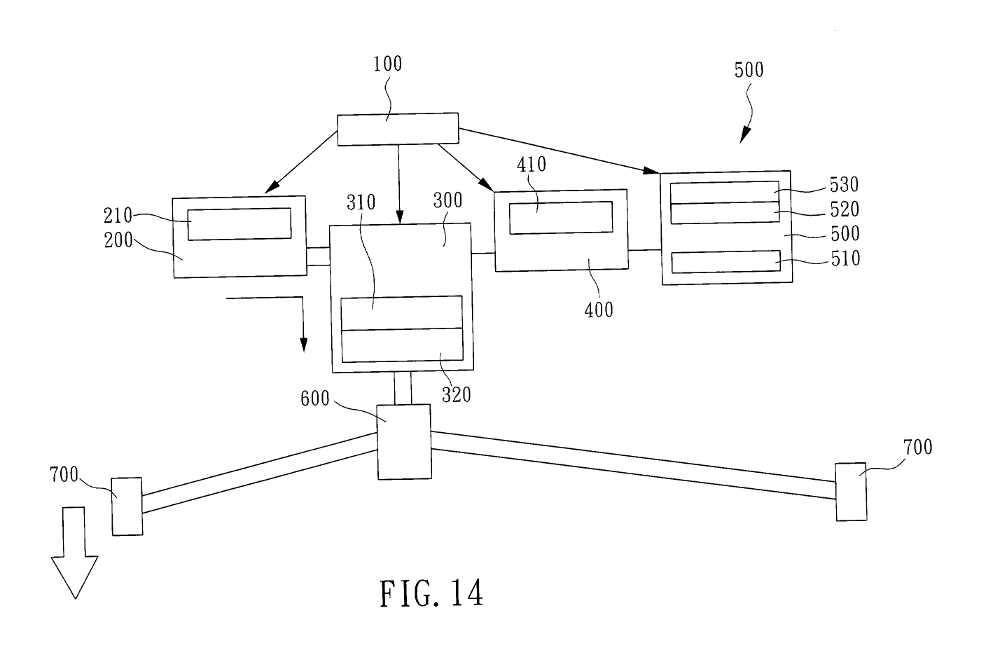

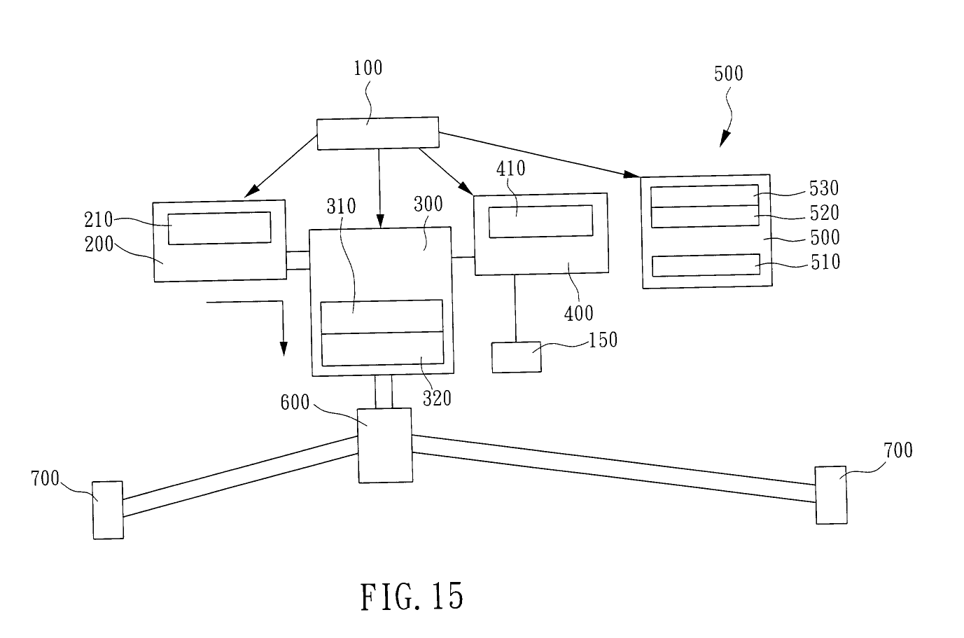

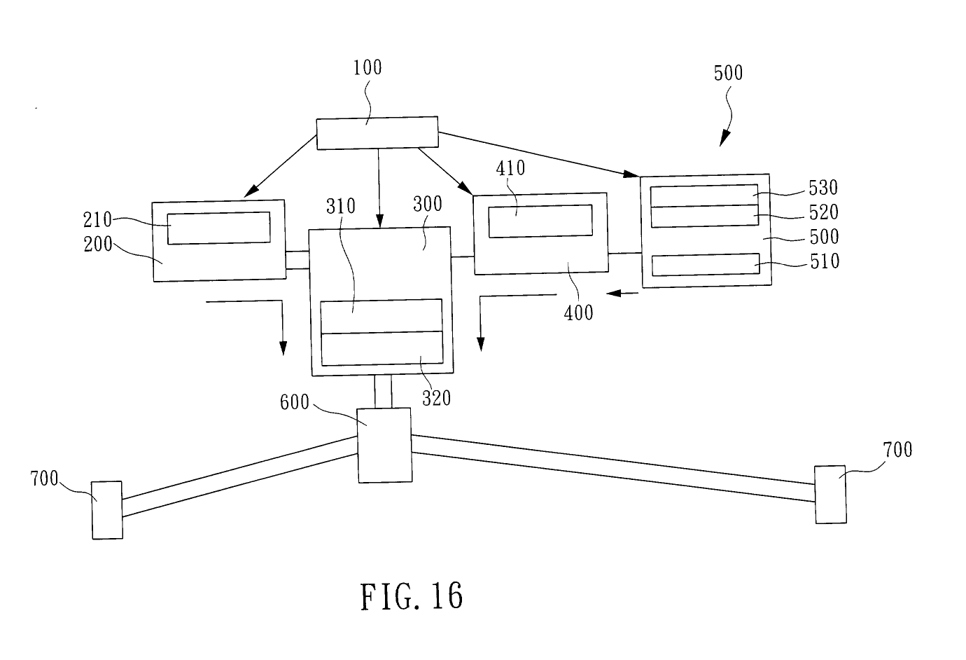

Please refer to FIGS. 5 to 15, which are preferred embodiments of the present invention; FIG. 5 shows only electric driving apparatus 200 executes driving motion, meanwhile fuel driving apparatus 400 does not connect to auto-control clutch apparatus 300 yet, rotation rate range is between 0 and 6000 rpm for electric driving apparatus 200, an arrow means the driving motion is activated by electric driving apparatus 200; FIG. 6 shows also electric driving apparatus 200 executes driving motion but under conditions of starting move and slow speed of vehicle, rotation rate range is between 0 and 4500 rpm for electric driving apparatus 200, an arrow means the driving motion is activated by electric driving apparatus 200; FIG. 7 shows electric driving apparatus 200 connects to fuel driving apparatus 400 in parallel via auto-control clutch apparatus 300 for driving under conditions of middle/low speed and general loading, simultaneously running loading in high efficiency area of fuel driving apparatus 400 can be adjusted by means of integrated power assistant apparatus 500, rotation rate range for fuel driving apparatus 400 is between 0 and 4500 rpm, two arrows mean driving motion is driven by electric driving apparatus 200 and fuel driving apparatus 400; FIG. 8 shows fuel driving apparatus 400 executes driving motion under conditions of high speed and general loading, meanwhile running loading in high efficiency area of fuel driving apparatus 400 can be adjusted by means of integrated power assistant apparatus 500, rotation rate range for fuel driving apparatus 400 is between 0 and 4500 rpm, an arrow means driving motion is driven by fuel driving apparatus 400; FIG. 9 shows fuel driving apparatus 400 executes driving motion under conditions of high speed and heavy loading, meanwhile integrated power assistant apparatus 500 can approach power assistant, and its rotation rate range is between 0 to 4500 rpm, two arrows mean driving motion is driven by fuel driving apparatus 400 and power assistant is from integrated power assistant apparatus 500; FIG. 10 shows fuel driving apparatus 400 cooperates with electric driving apparatus 200 in parallel under conditions of middle speed and heavy loading, meanwhile maximum power output can be approached via integrated power assistant apparatus 500, and rotation rate is between 0 to 4500 rpm, three arrows mean fuel driving apparatus 400 adds electric driving apparatus 200 and integrated power assistant apparatus 500 up for driving motion; FIG. 11 shows a condition of a battery (not shown in figure) in integrated power assistant apparatus 500 is low energy respectively, and electric driving apparatus 200 is in motion of brake, kinetic energy is transformed to electric energy at first moment, incessantly the electric energy is capable to be recharged back to the battery, arrow means electric driving apparatus 200 are enhanced reverse driving by brake; FIG. 12 shows a condition of a battery (not shown in figure) in integrated power assistant apparatus 500 is low energy respectively, and electric driving apparatus 200 is in motion of brake, kinetic energy is transformed to electric energy, incessantly the electric energy is capable to be recharged back to the battery, then internal combustion engine apparatus 400 helps to execute engine brake for maximum brake assistant, rotation rate range is between 0 to 4500 rpm, two arrows mean electric driving apparatus 200 and fuel driving apparatus 400 engage reverse driving and energy recharged back to battery; FIG. 13 shows high energy in battery is because of engine brake recharging, rotation rate range is between 0 and 4500 rpm, arrow means electric power being recharged back to battery via engine brake; FIG. 14 shows electric driving apparatus 200 voluntarily executes reverse driving to move back vehicle, rotation rate range is between 0 and 4500 rpm, arrow means reverse driving and vehicle moving of electric driving apparatus 200; FIG. 15 shows fuel driving apparatus 400 can attach an external power source 150 to start fuel driving apparatus 400 for generating power in high rotation rate under condition of battery being without any power; FIG. 16 shows electric driving apparatus 200 combines fuel driving apparatus 400 and integrated power assistant apparatus 500 to produce maximum climbing power under condition of initial climbing, rotation rate range is between 0 and 6000 rpm, three arrows mean power cooperation of electric driving apparatus 200, fuel driving apparatus 400 and integrated power assistant apparatus 500.

The present invention which system construction has several extensional embodiments depending on different types of power source cooperation:

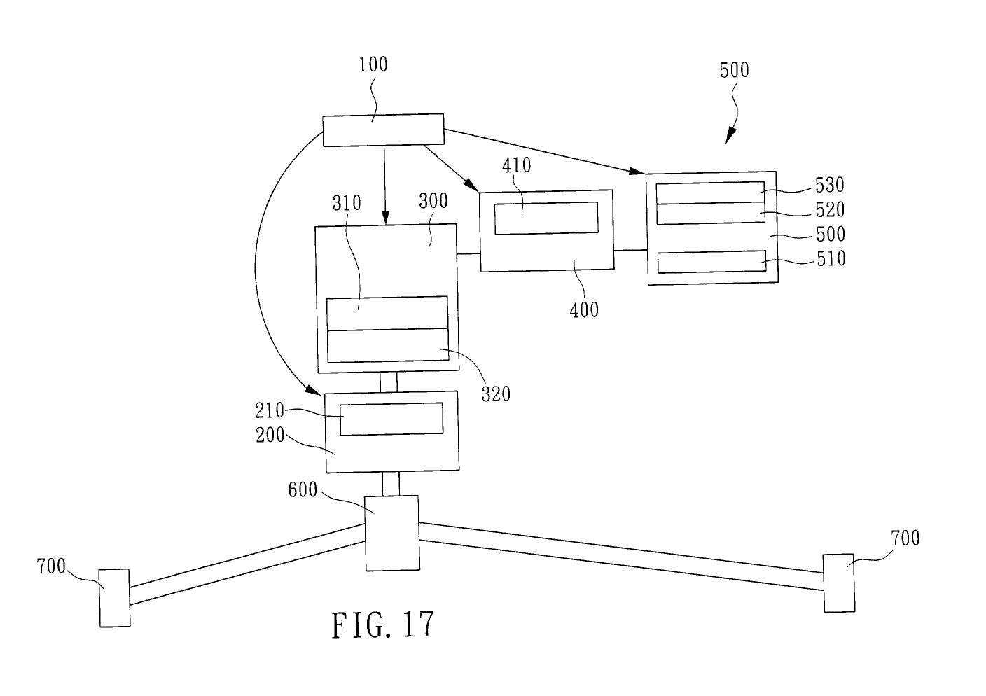

1. referring to FIG. 17, moving electric driving apparatus 200 and auto-control clutch 310 of auto-control clutch apparatus 300 to a rear axis of continuous variable transmission 320, at the embodiment, motor must be with higher torque and running area.

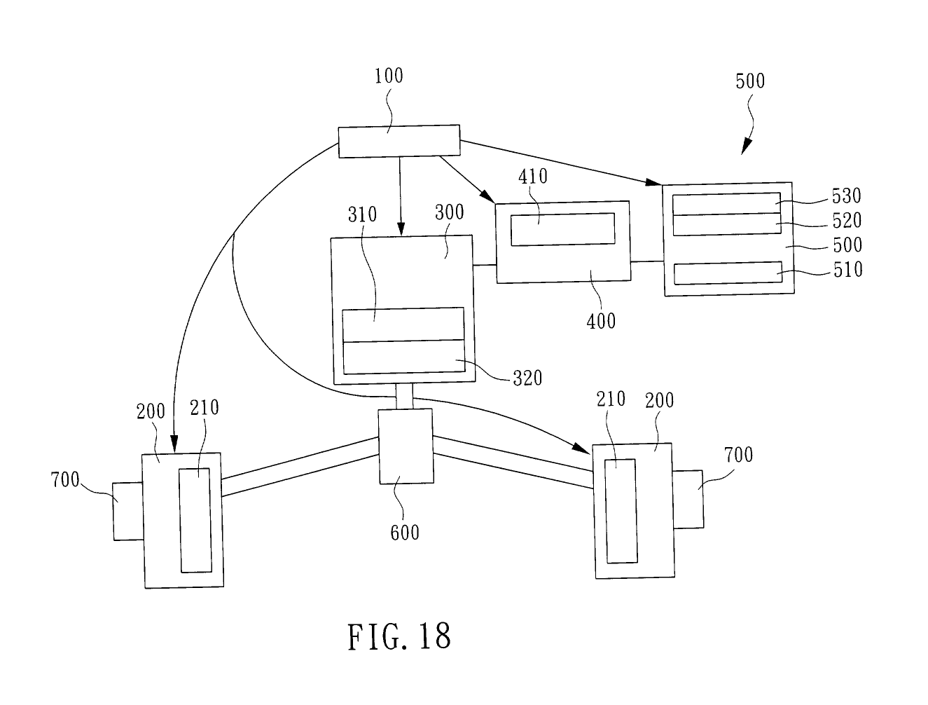

2. referring to FIG. 18, moving auto-control clutch 310 of auto-control clutch apparatus 300 to a rear axis of continuous variable transmission 320, and repositioning electric driving apparatus 200 to a hub of wheels 700, same, motor must be with higher torque and running area.

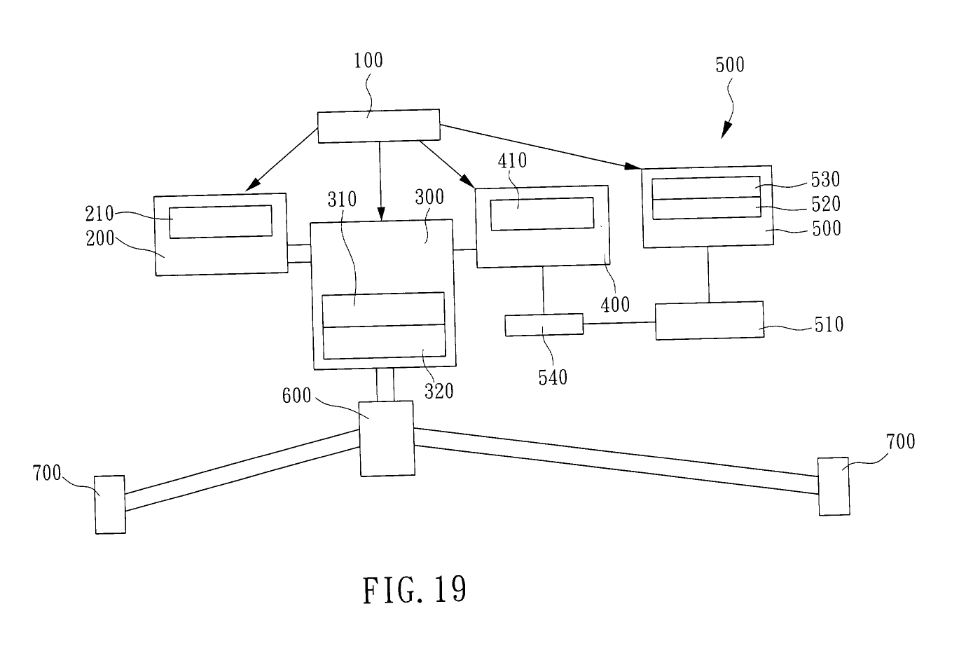

3. referring to FIG. 19, and if there is a space frame for power sources' cooperation, starting generator 510 of integrated power assistant apparatus 500 may shift to outside and be driven by a belt 540.

While the present invention has been shown and described with reference to preferred embodiments thereof, and in terms of the illustrative drawings, it should be not considered as limited thereby. Thus, the present invention is infinitely used. However, various possible modification, omission, and alterations could be conceived of by one skilled in the art to the form and the content of any particular embodiment, without departing from the scope and the sprit of the present invention.

The invention is disclosed and is intended to be limited only the scope of the appended claims and its equivalent area.

What is claimed is:

1. A hybrid power driving apparatus using different types of power sources and compound them cooperating with each other, the hybrid power driving apparatus comprising:
at least one controlling system apparatus, which controlling coordinating actions among components;
at least one electric driving apparatus, which being a first driving source and driven by electric power;
at least one fuel driving apparatus, which being a second driving source and driven by fuel;
at least one auto-control clutch apparatus, which handling clutching actions between the fuel driving apparatus and the electric driving apparatus, namely the auto-control clutch apparatus being in between fuel driving apparatus and electric driving apparatus to separate and combine both.

2. The hybrid driving apparatus as cited in claim 1, wherein fuel driving apparatus connects to an integrated power assistant apparatus, and fuel driving apparatus is in a middle position of auto-control clutch apparatus and the integrated power assistant apparatus in series, fuel driving apparatus is fast started by the starting generator, after fuel driving apparatus is started, integrated power assistant apparatus is then changed its role as a generator for sharing running loading of fuel driving apparatus, on the other hand, if further power is still needed, integrated power assistant apparatus immediately switches to a role of auxiliary power.

3. The hybrid driving apparatus as cited in claim 1, wherein hybrid driving apparatus means electric power apparatus connects to fuel driving apparatus and integrated power assistant apparatus via auto-control clutch apparatus.

4. The hybrid driving apparatus as cited in claim 1, wherein the different types of power sources can be an assembly of following: electric power, fuel, solar energy, etc.

5. The hybrid driving apparatus as cited in claim 1, wherein the electric driving apparatus is a motor.

6. The hybrid driving apparatus as cited in claim 1, wherein fuel driving apparatus and auto-control clutch apparatus are always departed of a mechanism, which is controlled by an auto-control clutch of auto-control clutch apparatus.

7. The hybrid driving apparatus as cited in claim 1, wherein the fuel driving apparatus is an engine.

8. The hybrid driving apparatus as cited in claim 1, wherein the fuel can be one of following: gasoline, diesel oil, etc.

9. The hybrid driving apparatus as cited in claim 1, wherein the auto-control clutch apparatus further includes an auto-control clutch and a continuous variable transmission, auto-control clutch departs and combines fuel driving apparatus and electric driving apparatus for parallel connection driving, the continuous variable transmission and electric driving apparatus are always combined together of a mechanism.

10. The hybrid driving apparatus as cited in claim 1, wherein the integrated power assistant apparatus further includes a starting generator and a multi-stage power switch unit.

11. A method for controlling a hybrid driving apparatus using different types of power sources and compound them cooperating with each other, steps for the method comprising:
step 1: a plurality of message receiving and dispatching apparatuses receiving plural related messages;
step 2: the plural messages being transferred and recorded to related plural controlling apparatus;
step 3: the plural controlling apparatus transmitting messages to a controlling system apparatus;
step 4: the controlling system apparatus reading and handling messages;
step 5: the messages, read and handled by controlling system apparatus, being transformed to instructions, which being transferred to their relative controlling apparatuses as well;
step 6: the relative controlling apparatuses comparing the transformed and transferred instructions with the plural messages in step 2, if not, then moving to next step, if yes, then moving to step 8;
step 7: adjusting the instructions for equivalent of instructions and messages, then going to step 1;
step 8: the instructions being thus delivered to message receiving and dispatching apparatuses;
step 9: message receiving and dispatching apparatuses sending the instructions out to relative apparatuses for execution.

12. The method for controlling the hybrid driving apparatus as cited in claim 11, wherein the different types of power sources can be an assembly of following: electric power, fuel, solar energy, etc.

13. The method for controlling the hybrid driving apparatus as cited in claim 11, wherein the plural controlling apparatus of step 2 include a controlling engine unit handling a fuel driving apparatus, a multi-stage power switch unit handling an integrated power assistant apparatus, a controlling motor unit handling an electric driving apparatus and a controlling battery unit handling the integrated power assistant apparatus.

14. The method for controlling the hybrid driving apparatus as cited in claim 11, wherein the controlling system apparatus of step 3 which internal software executes following functions:
(1) message acquirement;
(2) message communication;
(3) controlling system derivation;
(4) plural instruments' messages recording;
(5) messages judgments.

15. The method for controlling the hybrid driving apparatus as cited in claim 14, wherein function (3) is capable to execute following sub-functions:
(1) power sources combining modes selections;
(2) plural power sources operation conditions judgments.

16. The method for controlling the hybrid driving apparatus as cited in claim 11, wherein the relative apparatuses of step 9 include an electric driving apparatus, a fuel driving apparatus and an integrated power assistant apparatus.

17. The method for controlling the hybrid driving apparatus as cited in claim 16, wherein the electric driving apparatus is a motor.

18. The method for controlling the hybrid driving apparatus as cited in claim 16, wherein the fuel driving apparatus is an engine.

19. The method for controlling the hybrid driving apparatus as cited in claim 16, wherein the integrated power assistant apparatus further includes a starting generator and a multi-stage power switch unit.

20. The method for controlling the hybrid driving apparatus as cited in claim 16, wherein an auto-control clutch departs and combines the fuel driving apparatus and the electric driving apparatus for parallel connection driving.
